(19) United States
(12) Patent Application Publication
(10) Pub. No.: US 2022/0345008 A1
(43) Pub. Date: Oct. 27, 2022

(54) ELECTRICAL MACHINE

(71) Applicant: Schaeffler Technologies AG & Co. KG, Herzogenaurach (DE)

(72) Inventors: Andreas Ruppert, Bühlertal (DE); Michael Marsetz, Ettlingen (DE)

(73) Assignee: Schaeffler Technologies AG & Co. KG, Herzogenaurach (DE)

(21) Appl. No.: 17/640,391

(22) PCT Filed: Jul. 22, 2020
(86) PCT No.: PCT/DE2020/100642

§ 371 Date: Mar. 4, 2022

(30) Foreign Application Priority Data
Sep. 9, 2019 (DE) 10 2019 124 088.3

(51) Int. Cl. H02K 11/25; H02K 11/215; H02K 5/22

(52) U.S. Cl. CPC H02K 11/25; H02K 11/215; H02K 5/22

(57) ABSTRACT

An electrical machine includes a stator; a rotor, which can be rotated relative to the stator; a temperature-sensing device for sensing a temperature of the stator, which temperature-sensing device comprises a temperature sensor; and a rotor-sensing device for sensing the rotational speed and/or rotational position of the rotor. The rotor-sensing device includes a rotor-state-sensing sensor. The temperature-sensing device and the rotor-sensing device are connected to form a common assembly. The temperature-sensing device has a sensor portion, which can be moved between two end positions by means of at least one spring element and which includes the temperature sensor.

### CROSS-REFERENCE TO RELATED APPLICATIONS

This application is the U.S. National Phase of PCT Appln. No. PCT/DE2020/100642 filed Jul. 22, 2020, which claims priority to DE 10 2019 124 088.3 filed Sep. 9, 2019, the entire disclosures of which are incorporated by reference herein.

### TECHNICAL FIELD

The disclosure relates to an electrical machine, comprising: a stator; a rotor, which can be rotated relative to the stator; a temperature-sensing device for sensing a temperature of the stator, which temperature-sensing device comprises a temperature sensor; and a rotor-sensing device for sensing the rotational speed and/or rotational position of the rotor.

### BACKGROUND

Such an electrical machine is used, for example, as a drive for a motor vehicle such as a car, truck, bus or other commercial vehicle. It can be connected into a drive train, or serve as the hub drive of a hybrid vehicle or an electric vehicle. A known electrical machine as used in hybrid vehicles is known, for example, from DE 10 2017 116 232 A1, where a hybrid module for a drive train of a motor vehicle with a rotor position sensor and a temperature sensor is disclosed.

Thus, various sensors are already used in known applications, which sense different parameters relevant to the operation of the electrical machine. One is a sensor for sensing rotor information related to rotational speed or rotational position relative to the stator, that is, rotational and/or angular information, for which purpose a corresponding rotor-state-sensing sensor is used as part of a rotor-sensing device. On the other hand, a temperature sensor is used as part of a temperature-sensing device, which is used to sense a temperature of the stator, wherein an NTC or PTC resistive element is predominantly used as the sensor.

In order to minimize the effects of torsion and tolerances on the sensors during operation, they are mounted as close as possible to the electrical machine or the components to be sensed, wherein they are usually integrated into a housing of the electrical machine. However, it has turned out to be a disadvantage that the sensors usually have to be connected individually to their housing, for example via screw connections, which means that each sensor or sensing device is a separate component that also has to be mounted separately. As a result, there is a relatively high installation effort. Furthermore, various winding technologies exist for the coils of the electrical machine, for example the hairpin or bar wave winding. These winding technologies result in very tightly wound windings, which makes it difficult to place the temperature sensor directly on or in the winding, so that the sensor often has to be placed at a distance from the winding, thus measuring the winding temperature only indirectly.

### SUMMARY

The disclosure is based on the problem of specifying an electric machine that is improved in comparison.

To solve this problem, in an electrical machine of the type mentioned at the outset, it is provided in accordance with the disclosure that the temperature-sensing device and the rotor-sensing device are connected to form a common assembly, wherein the temperature-sensing device has a sensor portion, which can be moved between two end positions via at least one spring element and comprises the temperature sensor.

According to the disclosure, the temperature-sensing device and the rotor-sensing device are designed as a common assembly, which significantly simplifies the assembly work. This is because only this one assembly has to be mounted in order to position both sensing devices on the stator side. This means that now, after the stator of the electrical machine has been mounted in a machine housing and after the rotor, which has a component sensed by the stator-side rotor-state-sensing sensor, has been mounted, the single-piece sensor system is mounted as a whole, including the rotor-state-sensing sensor and the temperature sensor, for example on the cover of the electrical machine. In addition to a simplified assembly, which can also be automated, there are fewer tolerances due to the reduced number of components, which is advantageous with regard to correct positioning of the sensors.

With regard to the correct positioning or contacting of the temperature sensor, the disclosure further provides that the temperature sensor is not permanently mounted on the assembly, but is movable. For this purpose, the temperature sensor is arranged on a sensor portion that is movable relative to the entire assembly or an assembly housing or the like. At least one spring element is used to move the sensor portion between two end positions. This movability makes it possible to react extremely flexibly to any tolerances, as these can be easily compensated for, so that the temperature sensor can always be positioned correctly in direct contact with the component whose temperature is to be sensed. This means that when assembling the module, it is ultimately only necessary to work as accurately as possible when positioning the rotor status sensor, while a high degree of flexibility is provided when positioning the temperature sensor with regard to clearance or distance compensation.

As described, the temperature sensor or the sensor portion is spring loaded via the at least one spring element so that it can be moved relative to the component or the component housing on the one hand, but on the other hand the temperature sensor can also be brought into contact with the component to be sensed with a defined pressure force. It is useful if two spring elements are provided to spring the sensor portion, on the one hand to realize a sufficiently high contact pressure and a symmetrical application of force, and on the other hand to continue to spring the temperature sensor into the correct position via the second, redundant spring element in the event of failure of one spring element.

Preferably, the sensor portion is radially movable relative to the assembly. As described, the assembly itself is preferably arranged on a cover of the machine housing or stator, and in this case preferably in the region of the winding head, i.e., for example, at an axial end of the hairpin or bar wave winding, in order to measure the temperature directly at the winding area. In order to make the electrical machine as compact and small-format as possible, the assembly, the housing of which, following the cylindrical winding geometry, is designed, for example, in the form of a circular arc segment, is preferably positioned inside the winding or winding head so that the sensor portion in this case can be moved radially outwards from the outer circumference of the component or component housing. If the assembly is arranged radially outside the winding or the winding head, the sensor portion would naturally be movable radially inwards.

The temperature-sensing device itself expediently has a housing from which and into which the sensor portion is movable. The temperature-sensing device is thus largely encapsulated, wherein the sensor portion on which the temperature sensor is arranged is also arranged on the housing of the temperature-sensing device in a largely or completely sealed manner despite its movability.

In this case, the housing of the temperature-sensing device can be integral with the housing of the rotor-sensing device, that is, the assembly has a common housing. Alternatively and preferably according to the disclosure, however, the housing of the temperature-sensing device is detachably arranged on a housing of the rotor-sensing device and electrically coupled to connection elements provided there and associated with a downstream electrical or electronic device. This means that the assembly consists of two separate but detachably connectable housings, one being the temperature-sensing device housing, the other being the rotor-sensing device housing. Since, of course, the signals supplied by the temperature sensor are to be passed on to a downstream electrical or electronic device, usually a corresponding control or processing device, a detachable electrical coupling of the temperature sensor to this downstream device is also provided in that corresponding contact elements are provided on the housing of the temperature-sensing device which, when the two housings are joined, are automatically coupled to corresponding connection elements on the housing of the rotor-sensing device. This means that the electrical connection is automatically closed when the two housings are connected.

According to the disclosure, for a simple but safe connection, the housing of the temperature-sensing device can have a coupling portion with a U-shaped cross-section at which the contact elements for electrically connecting the temperature sensor to the connection elements are provided, which are arranged at a connecting portion of the housing of the rotor-sensing device to be accommodated in the coupling portion, or vice versa. This means that, preferably, the housing of the temperature-sensing device has an encompassing plug-in coupling portion into which a corresponding, for example planar, connecting portion of the housing of the rotor-sensing device is inserted, wherein the corresponding contact and connection elements are provided in the encompassing region. Via these, a connection is provided to the downstream electrical or electronic device, which serves for signal transmission or also for the power supply of the temperature sensor. In addition, the geometrical design of the two housings can of course also be reversed, i.e., the housing of the rotor-sensing device has the U-shaped connecting portion into which the then rather flat coupling portion of the housing of the temperature sensor device is inserted.

As described, it is of course necessary to couple the temperature sensor to the downstream electrical or electronic device for signal transmission or power supply, etc. In the case of non-detachable housings on the part of the two devices, this can be realized, for example, by means of appropriate cables leading from the temperature sensor to a connection plug on the housing of the component assembly. However, due to the movability of the sensor portion, these cables would be moved as part of the assembly process when the sensor portion extends or retracts to assume its final mounting position, which can sometimes have a detrimental effect on the contact connection, the cable can become jammed, or the like. In the case of detachable housings, a cable connection is impractical anyway, since otherwise corresponding additional cable connections would have to be closed between the two housings. To remedy this, a particularly useful further development of the disclosure provides that the temperature sensor is electrically coupled to a downstream electrical or electronic device via the electrically conductive spring element or elements. As described, the spring element(s) is/are responsible for the spring loading and thus the movement of the sensor portion. According to the disclosure, the spring element or elements are now integrated into the electrical line connection, i.e., they are part of the signal or current line path by electrically coupling the temperature sensor to the downstream electrical or electronic device. This is particularly useful as it eliminates the need for any separate cable connection as far as the transition from the movable sensor portion to fixed-position connections or lines within the component assembly is concerned.

For the electrical integration of the spring element(s), it is convenient if the temperature sensor is connected to one or two sensor-side contact shoes at which the spring element(s) are electrically contacted. Since the temperature sensor usually has a two-core cable, two sensor-side contact shoes are preferably provided, wherein in this case two separate spring elements are then also provided, one each for the corresponding line path, which are then each coupled to a corresponding connection element at the other end.

For this coupling at the other end, it is convenient if the spring element or elements are electrically contacted with the other end at one or each of a further contact shoe which can be coupled with the connection elements on the housing of the rotor-position-sensing device. Consequently, one or preferably two corresponding connection shoes are also provided at this end so that defined connection conditions for the spring element(s) also result there, wherein the contact shoe(s) is/are directly coupled to corresponding connection elements on the housing of the rotor-position-sensing device, irrespective of whether a common assembly housing is provided or separate, detachable housings.

The or each spring element itself is preferably designed as a helical spring, which can also be designed as an electrically conductive element without issue. However, it is also conceivable to design the or each spring element as an elastomer component, in particular a silicone, wherein the elastomer component is to be given a corresponding conductivity in the event that electrical coupling is also to be performed via this elastomer component.

### BRIEF DESCRIPTION OF THE DRAWINGS

The disclosure is explained below on the basis of exemplary embodiments with reference to the drawings. The drawings are schematic representations, wherein:

FIG. 1 shows a partial view of an electrical machine according to the disclosure with the end cover of the housing and the stator winding as well as the assembly not yet mounted,

FIG. 2 shows the arrangement in FIG. 1 with the assembly mounted on the cover on the inside of the winding,

FIG. 3 shows an enlarged partial view from FIG. 2 in the region of the contact of the sensor portion of the temperature-sensing device with the temperature sensor on the winding,

FIG. 4 shows a perspective view of the temperature-sensing device with the sensor portion fully extended,

FIG. 5 shows the temperature-sensing device of FIG. 4 with the sensor portion partially retracted,

FIG. 6 shows the temperature-sensing device with the sensor portion fully retracted,

FIG. 7 shows a partial cutaway perspective view of the temperature-sensing device of FIG. 5, and

FIG. 8 shows a perspective view of the rotor-sensing device.

### DETAILED DESCRIPTION

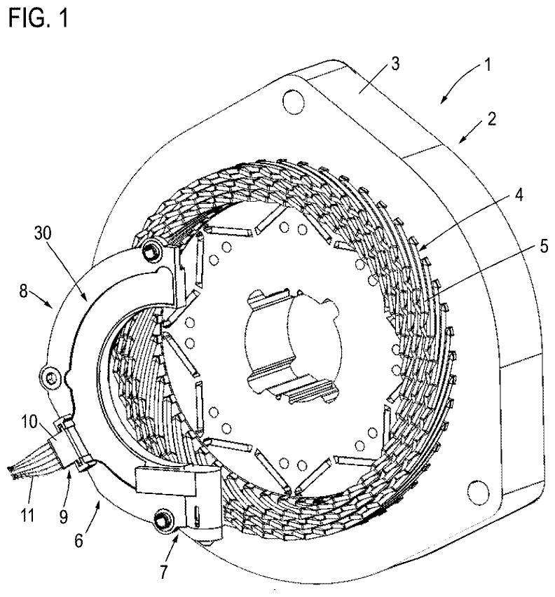

FIG. 1 shows a partial view of an electrical machine 1 according to the disclosure, such as can be used for the drive of a motor vehicle, in an exploded view. Shown is the part of a stator 2 with a cover 3 and a winding 4 whose winding head 5 protrudes from the cover 3. Not shown in more detail, but sufficiently known, the electrical machine naturally also comprises a corresponding rotor, rotatable within the stator, which is occupied by corresponding magnets and which can be rotated by means of an electric traveling field generated on the part of the winding 4.

Further provided is an assembly 6 comprising both a temperature-sensing device 7 and a rotor-sensing device 8. The temperature-sensing device 7 is used to sense a temperature of the stator, in this case a temperature at the winding 4. The rotor-sensing device 8, which has a corresponding rotor position sensor that senses a component arranged on the rotor and rotating with it, is used to sense the rotational speed and/or rotational position of the rotor relative to the stator 2. The functions of the two separate devices are also well known.

Both devices 7, 8 are part of a common assembly 6, i.e., to be mounted as a single component, although the two devices 7, 8 are detachable from one another, i.e., both have separate housings which, as will be discussed below, can be detachably mounted to one another.

As will be discussed below, the temperature-sensing device 7 comprises a temperature sensor, while the rotor-sensing device 8 comprises a rotor state sensor. Both therefore supply corresponding sensor signals and must also be supplied with power, for which purpose a corresponding plug-in connection 9 is provided on the module 6, where a connection plug 10 is to be plugged in, from which connection lines 11 run to a downstream electrical or electronic device which is used for signal processing or control or for the power supply.

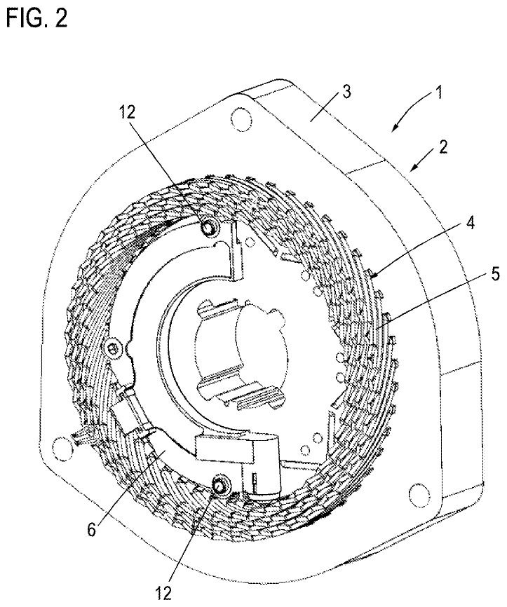

FIG. 2 shows the arrangement from FIG. 1, wherein here the assembly 6 is mounted on the cover 3 of the stator 2. The assembly 6 is placed in the inner circumference of the winding 4 or winding head 5 and fixed in position on the cover 3 by means of corresponding connecting screws 12, which are screwed into corresponding threaded holes in the cover 3. On the one hand, the rotor-state-sensing device or the rotor-state-sensing sensor is positioned accordingly to interact with the rotor-side component. The rotor-state-sensing sensor is a rotor position sensor, which can be of the type of a resolver, an eddy current sensor, a GMR sensor (GMR=Giant Magnetoresistance) or similar.

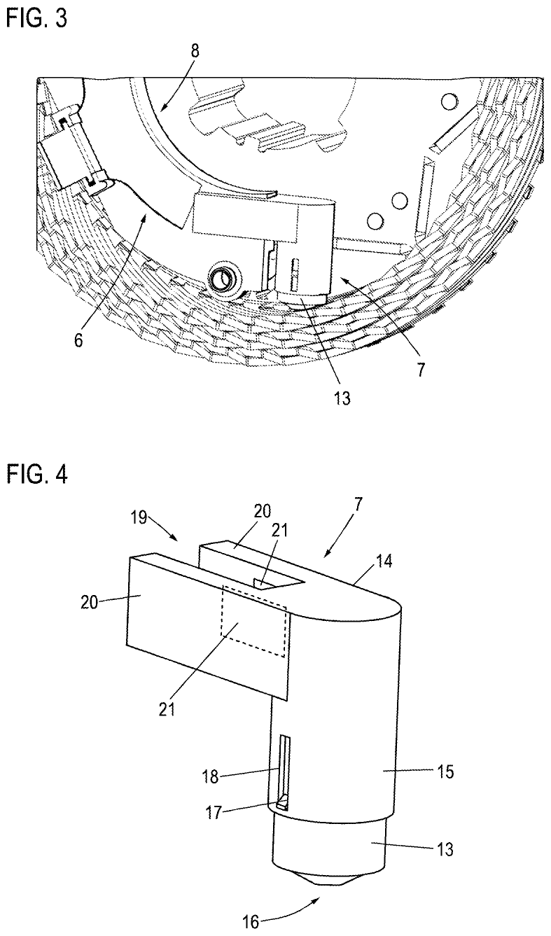

The temperature sensor of the temperature-sensing device 7 is also correctly positioned after the assembly 6 has been mounted and, in the example shown, brought into defined contact with the inner circumference of the winding head 5, as shown in particular in FIG. 3. For this purpose, a sensor portion 13 is provided on the temperature-sensing device 7, which is movable relative to the assembly 6. In the example shown, it is movable radially outward relative to the assembly 6. The temperature sensor, usually a PTC or NTC resistive element, is arranged at the end of this sensor portion 13 and is preferably injected or pressed in there. It can be provided with an appropriate protective layer, for example made of an elastomer such as a silicone elastomer or similar. In any case, it is brought into direct contact with the winding head 5 by pressing the sensor portion 13, which, as will be discussed below, is spring loaded via two spring elements, and pressed radially outwards. Due to this radial movability, it is also possible to bridge larger distances to the winding head 5 and at the same time bring the temperature sensor into a defined contact.

This is shown in detail in FIGS. 4 to 6. FIG. 4 shows the temperature-sensing device 7, which has a housing 14, which here has a cylindrical portion 15, into and out of which the sensor portion 13, which is also cylindrical, can be moved. The temperature sensor 16 is located at the lower, free, leading end of the sensor portion 13. In FIG. 4, the sensor portion 13 is fully extended and a stop element 17, which extends through a longitudinal slot 18 in the cylindrical housing portion 15, is moved against the lower end of the slot.

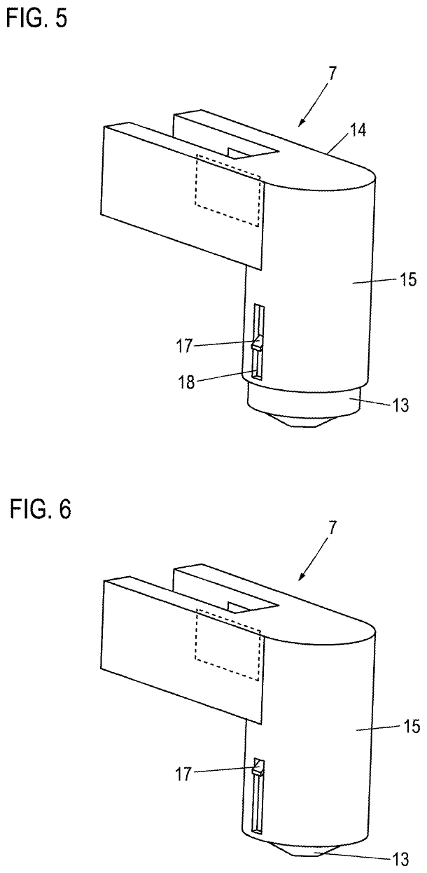

FIG. 5 shows the temperature-sensing device 7 with the sensor portion 13 partially retracted into the housing portion 15, while the stop element 17 is in a center position in the slot 18.

Finally, FIG. 6 shows the temperature-sensing device 7 with the sensor portion 13 almost completely retracted into the cylindrical housing portion 15, while the stop element 17 is located in the stop at the upper slot end. This means that the stop element 17 and the slot 18 provide two defined end positions, namely the maximum extended position and the maximum retracted position, between which the sensor portion 13 and the temperature sensor 16 can be moved. This displacement length allows considerable tolerance-related compensation of the distance to the contact surface on the winding head 5.

As already described above, the temperature-sensing device 7 and the rotor-sensing device 8 are detachable from one another, for which purpose on the one hand the temperature-sensing device 7 has a housing 14, and on the other hand the rotor-sensing device 8 has a corresponding housing 30. In order to connect both housings 14, 30 to one another in a simple manner, but at the same time, as will be discussed below, to realize an electrical connection of the temperature sensor 16 to a downstream electrical or electronic device via the plug-in connection 9, the temperature-sensing device 7 or the housing 14 has a coupling portion 19 with a U-shaped cross-section, which has two legs 20, on the inner sides of which two contact elements 21 (which are partly shown dashed in FIGS. 4 to 6 and 7) are provided.

The rotor-sensing device 8 or its housing 30 has a connecting portion 22, see FIG. 8, which is designed and dimensioned in such a way that it can be inserted between the legs 20, i.e., into the U-shaped coupling portion 19. Two connection elements 23 are provided on both sides of the connecting portion 22, which automatically make contact with one another when the housings 14 and 30 are pushed together so that both housings are electrically connected to one another. Since the two contact elements 21 are also electrically connected to the temperature sensor 16 at the same time, there is consequently an electrical connection of the temperature sensor 16 to the connection elements 23, which in turn are connected to corresponding contacts in the region of the plug-in connection 9, so that ultimately the temperature sensor 16 is coupled via this to the downstream electrical or electronic device.

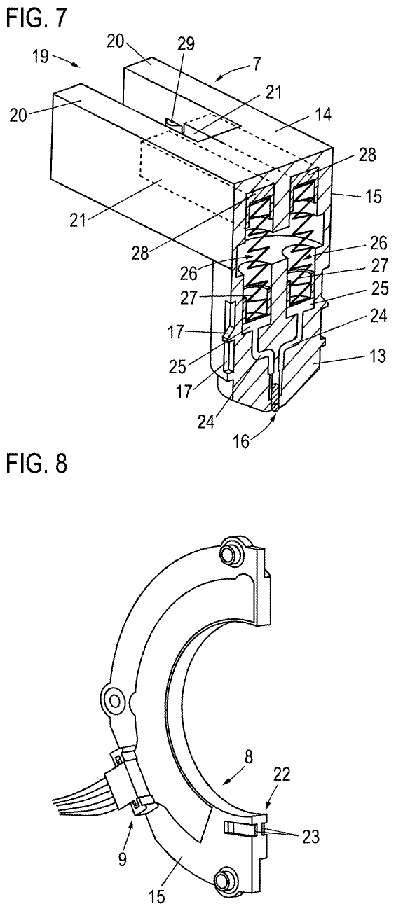

FIG. 7 shows a sectional view through the temperature-sensing device 7, wherein the cylindrical housing portion 15 as well as the sensor portion 13 are shown in section.

At the sensor portion 13, the temperature sensor 16, for example an NTC resistive element, sometimes also called an NTC pearl, which is embedded in silicone for protection purposes, for example, is arranged at its tip. Here, the temperature sensor 16 is connected to two contact shoes 25 via two connection lines 24. The contact shoes 25 are attached to the sensor portion 13.

To move the sensor portion 13 relative to the housing 14, two electrically conductive spring elements 26 are provided here in the form of helical springs 27, the lower end of which rests against the contact shoes 25, thus spring loading them. The other ends of the spring elements 26 are supported on further contact shoes 28, which contact shoes 28 are fixed in the housing 14 and are connected to the two contact elements 21.

The two spring elements 26 have a dual function. On the one hand, they spring the sensor portion 13, thus continuously quasi pressing it out of the housing 14. The sensor portion 13 can be pressed into the housing portion 15 against the restoring force of the spring elements 26. On the one hand, this ensures automatic positioning of the sensor portion 13 and thus of the temperature sensor 16 in relation to the component whose temperature is to be sensed, in this case the winding head 5, and a defined contact. In addition, as a second function, the two spring elements 26 also serve as electrically conductive transmission elements after they electrically connect the contact shoes 25 and 28 to one another. For this purpose, the spring elements 26 are made of a conductive material, usually metal, so that a signal transmission from the temperature sensor to the downstream electrical or electronic device and vice versa as well as a power supply or the like is possible via this. Any cable connection is therefore not required in this region.

Instead of a helical spring 27 as the spring element 26, it is also conceivable to use an electrically conductive elastomer element, for example made of a silicone elastomer, which fulfills the tasks of spring loading and of the electrically conductive connection.

Finally, FIG. 7 shows a lug 29 which serves to mount the housing 14 on the housing 30, i.e., which is inserted as a mounting coding into a corresponding guide groove in the housing 30, so that a positionally exact arrangement of the housing 14 on the housing 30 is thus possible.

Finally, there is also the possibility of providing the sensor portion 13 with a copper core via which the temperature can be conducted to the temperature sensor, wherein another conductive material can also be used.

As the above description of figures shows, the electrical machine according to the disclosure has a number of advantages over known electrical machines. The use of only one assembly group for the two sensing devices means that less assembly work is required, and fewer screw connections have to be made. In particular, an automatic assembly process is possible. Due to the smaller number of components, there are also fewer tolerances to compensate for. Any tolerances in the area of the temperature sensor positioning are compensated for by the integrated elasticity or spring loading of the sensor portion comprising the temperature sensor. Also, only one cable duct is required, since a common plug-in connection is provided as the connection of the two sensing devices to a downstream electrical or electronic device via only one, for example, 8-pin plug. Finally, since only one assembly is positioned, there is less machining to be done on the relevant components, especially the cover to which the assembly is attached. Another important advantage is that there is also no need to provide separate lines to connect the temperature sensor to the downstream electronic or electrical equipment.

### LIST OF REFERENCE SYMBOLS

1 Machine
2 Stator
3 Cover
4 Winding
5 Winding head
6 Assembly
7 Temperature-sensing device
8 Rotor-sensing device
9 Plug-in connection
10 Connection plug
11 Connection line
12 Connecting screw
13 Sensor portion
14 Housing
15 Portion
16 Temperature sensor
17 Stop element
18 Longitudinal slot
19 Coupling portion
20 Leg
21 Contact element
22 Connecting portion
23 Connection element
24 Connection line
25 Contact shoe
26 Spring element
27 Helical spring
28 Contact shoe
29 Lug
30 Housing

1. An electrical machine, comprising: a stator, a rotor configured to be rotatable relative to the stator, a temperature-sensing device for sensing a temperature of the stator, wherein the temperature-sensing device comprises a temperature sensor and a rotor-sensing device for sensing at least one of a rotational speed and a rotational position of the rotor, wherein the rotor-sensing device comprises a rotor-state-sensing sensor, wherein the temperature-sensing device and the rotor-sensing device are connected to form a common assembly, wherein the temperature-sensing device has a sensor portion configured to be movable between two end positions by at least one spring element and which comprises the temperature sensor.

2. The electrical machine according to claim 1, wherein the at least one spring element includes two spring elements spring loading the sensor portion.

3. The electrical machine according to claim 1, wherein the sensor portion is radially movable relative to the common assembly.

4. The electrical machine according to claim 1, wherein the temperature-sensing device has a housing from and into which the sensor portion is movable.

5. The electrical machine according to claim 4, wherein the housing is detachably arranged on a housing of the rotor-sensing device and is electrically coupled to one or more contact elements provided on a housing side on one or more connection elements associated with a downstream electrical or electronic device.

6. The electrical machine according to claim 5, wherein the housing of the temperature-sensing device has a coupling portion with a U-shaped cross-section at which the contact elements are provided for electrically connecting the temperature sensor to the connection elements, which are arranged at a connecting portion of the housing of the rotor-sensing device to be accommodated in the coupling portion.

7. The electrical machine according to claim 1, wherein the temperature sensor is electrically coupled to a downstream electrical or electronic device via the electrically conductive spring element.

8. The electrical machine according to claim 7, wherein the temperature sensor is connected to at least one sensor-side contact shoe at which the spring element is electrically contacted.

9. The electrical machine according to claim 8, wherein the spring element(s) is electrically contacted with the other end at a further contact shoe which can be coupled to connection elements on a housing of the rotor sensing device.

10. The electrical machine according to claim 1, wherein the spring element is designed as a helical spring.

11. The electrical machine according to claim 1, wherein the spring element is an elastomer component.

12. The electrical machine according to claim 11, wherein the elastomer component is made of a silicone elastomer.
